(19) United States
(12) Patent Application Publication
(10) Pub. No.: US 2006/0076898 A1
(43) Pub. Date: Apr. 13, 2006

(54) Printer head and image forming apparatus having the same

(75) Inventor: Takayuki Kitazawa, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/186,994

(22) Filed: Jul. 22, 2005

(30) Foreign Application Priority Data
Sep. 29, 2004 (JP) 2004-282977

(51) Int. Cl. G09G 3/10

(52) U.S. Cl. 315/169.3

(57) ABSTRACT

A printer head includes a plurality of current-driven light-emitting elements that are linearly disposed so as to expose a photosensitive member, and a plurality of pixel circuits, each having a driving transistor that is provided for each light-emitting element so as to cause a driving current to flow in the light-emitting element according to a data signal and a storage capacitor that holds an electric charge according to the data signal and having a gate of the driving transistor as one of a pair of capacitance electrodes and an interlayer insulating film interposed between the pair of capacitance electrodes as a dielectric film, such that a voltage according to the electric charge held in the storage capacitor is applied to the gate of the driving transistor.

### BACKGROUND

The present invention relates to a printer head or line head, such as an organic electroluminescent (EL) printer head or the like, that is used to expose a photosensitive member so as to form an electrostatic latent image in an image forming apparatus, such as a printer, a copy machine, a facsimile machine, or the like, and to an image forming apparatus having such a printer head.

In such an organic EL printer head, a plurality of organic EL light-emitting elements disposed linearly are sequentially turned on or off according to data signals at timings according to line scanning signals. Here, each pixel circuit is provided with the organic EL light-emitting element and a driving transistor that allows a driving current to flow in the organic EL light-emitting element. When the driving transistor is turned on according to the data signal, the driving current flows in the organic EL light-emitting element, and thus the organic EL light emitting element emits light according to the data signal (see Japanese Unexamined Patent Application Publication No. 11-274569).

There may be a case in which the light-emission time of the organic EL light-emitting element according to the driving current is required to be much longer than the supply time of each data signal that is sequentially supplied to each pixel circuit from a driving circuit, such as a data line driving circuit or the like, according to an active matrix driving method. For example, there may be a case in which a voltage corresponding to the data signal supplied via a control transistor is required to be applied to a gate of the driving transistor for a time much longer than the supply time of each data signal. Therefore, in general, a storage capacitor that holds the voltage corresponding to the data signal applied to the gate of the driving transistor is provided in each pixel circuit (see Japanese Unexamined Patent Application Publication No. 2000-315734).

However, first of all, since the pitch of the organic EL light-emitting elements in the printer head, that is, the pixel pitch, is smaller than that of an organic EL display according to the related art, naturally it is difficult to form the storage capacitor in each pixel circuit. More specifically, for example, when the display quality of the printed image is set to be 600 dpi or more, it is difficult to secure sufficient space to provide the storage capacitor for each pixel. Secondly, there are many cases in which the organic EL light-emitting elements for the printer head are required to have high luminance of, for example, about 5500 Cd/m² in order to form a high-quality image. Therefore, a sufficient width of the gate of the driving transistor must be secured so as to suppress a voltage drop at the gate, so that a sufficient voltage is applied to the gate of the driving transistor. However, as the occupied area of the gate in each pixel is increased, there is a problem in that it is difficult to secure a larger space for the storage capacitor. Moreover, if the storage capacitor is too large, the write time of the data signal into the pixel becomes hundreds of nanoseconds, and thus data may not be written into the pixel unit within the write time.

### SUMMARY

An advantage of the invention is that it provides a printer head that can secure a required storage capacitor for each pixel and secure sufficient luminance of an organic EL light-emitting element, even when a pixel pitch is small, as compared to an organic EL display according to the related art, and to an image forming apparatus having such a printer head.

According to an aspect of the invention, a printer head includes a plurality of current-driven light-emitting elements that are linearly disposed so as to expose a photosensitive member, and a plurality of pixel circuits, each having a driving transistor that is provided for each light-emitting element so as to cause a driving current to flow in the light-emitting element according to a data signal, and a storage capacitor that holds an electric charge according to the data signal and having a gate of the driving transistor as one of a pair of capacitance electrodes and an interlayer insulating film interposed between the pair of capacitance electrodes as a dielectric film, such that a voltage according to the electric charge held in the storage capacitor is applied to the gate of the driving transistor.

In accordance with the printer head of the aspect of the invention, for example, the current-driven light-emitting elements, such as the organic EL light-emitting elements or the like, are linearly disposed. Here, the ‘linear disposal’ includes a case where the light-emitting elements are disposed in two or more rows, or in a zigzag pattern, in addition to the case where the light-emitting elements are linearly disposed in a single row. The linear printer head can emit linear light from the light-emitting element row to the photosensitive member sequentially along the line direction in which the plurality of light-emitting elements are disposed. Further, the printer head can emit linear light from a part or all of the light-emitting element rows to the photosensitive member.

Under operation, in the printer head according to the aspect of the invention, the data signal indicating turning on or off is supplied from the outside, such as a printer engine or the like, on the basis of the pixel circuit provided for each light-emitting element. The driving transistor flow the driving current to the light-emitting element according to a gate signal, such that the light-emitting element emits light. Moreover, for example, a thin film transistor that is used for a pixel unit of an organic EL display may be used as the driving transistor.

The storage capacitor holds an electric charge corresponding to the data signal and applies a voltage according to the electric charge to the gate of the driving transistor, for example, for a constant time, such that the light-emitting element can emit light for a time much longer than the supply time of the data signal. The storage capacitor is constituted to have the gate of the driving transistor as one of the pair of capacitance electrodes and the interlayer insulating film interposed between the pair of the capacitance electrodes as the dielectric film, such that the storage capacitor holds the electric charge according to the data signal. Therefore, even when the interval between the light-emitting elements disposed linearly is narrow, the storage capacitor can be provided for each pixel circuit. Further, the voltage according to the electric charge held in the storage capacitor can be applied to the gate of the driving transistor. That is, the storage capacitor can be secured by using the element structure of the driving transistor, even when a capacitive element or the like, which functions as the storage capacitor, is not newly provided in the pixel circuit or another region of the printer head. More specifically, for example, the capacitance, which is generally called a gate capacitance, can be used as the storage capacitor.

As described above, in accordance with the printer head of the aspect of the invention, for example, the storage capacitor can be secured for every pixel circuit, even when the interval between the light-emitting elements is narrower than that in the organic EL display.

In the printer head according to the aspect of the invention, it is preferable that the storage capacitor is constituted by only the pair of capacitance electrodes and the dielectric film.

According to this configuration, the storage capacitor can be secured, even when a capacitive element or an element structure serving as the storage capacitor is not newly provided in a region where the pixel circuit is formed or another region. The storage capacitor can be secured by using the element structure, such as a transistor or the like included in the pixel unit, such that a space for the storage capacitor dose not need to be provided, even when the organic EL light-emitting elements are disposed at narrow intervals. Therefore, the size of the printer head can be reduced, without degrading the quality of a printed image. Moreover, it is needless to say that this configuration includes a case where an auxiliary storage capacitor, other than the storage capacitor, is provided additionally.

In the printer head according to the aspect of the invention, it is preferable that the other capacitance electrode includes at least one of a source region and a drain region in a semiconductor layer that includes a channel region of the driving transistor.

According to this configuration, for example, the storage capacitor can be constituted by the gate of the driving transistor, the interlayer insulating film that is provided between the gate and the channel region of the driving transistor, and at least one of the source region and the drain region in the semiconductor layer that includes the channel region. At this time, the gate insulating film functions as the dielectric film in the storage capacitor. Therefore, the storage capacitor can be secured by using the element structure of the driving transistor. As a result, it is unnecessary to secure a space to provide an additional storage capacitor.

In the printer head according to the aspect of the invention, it is preferable that the other capacitance electrode includes at least one of a source electrode and a drain electrode of the driving transistor.

According to this configuration, for example, in a planar thin film transistor in which the gate, the source electrode, and the drain electrode are provided on the same side with respect to the semiconductor layer including the channel region, the gate protective film or the interlayer insulating film that electrically isolates the gate, the source electrode, and the drain electrode from one another, can be used as the dielectric film to constitute the storage capacitor. Therefore, the storage capacitor can be secured by using the element structure of the driving transistor. Further, the storage capacitor can be secured, even when the interval between the light-emitting elements is narrow.

In the printer head according to the aspect of the invention, it is preferable that the plurality of pixel circuits are disposed in the arrangement direction of the plurality of light-emitting elements, and at least a portion of the gate that functions as one of the capacitance electrodes and the other capacitance electrode longitudinally extends in a direction intersecting the arrangement direction.

According to this configuration, even when the intervals of the plurality of pixel circuits disposed in the arrangement direction of the light-emitting elements disposed linearly are narrow, the storage capacitor can be secured, and the size of the storage capacitor can be set. For example, the space for the storage capacitor along the direction intersecting the arrangement direction of the light-emitting elements disposed linearly, rather than in the arrangement direction of the light-emitting elements, is easily secured, and the capacitance of the storage capacitor can be defined by extending the gate in the direction intersecting the arrangement direction of the light-emitting elements. More specifically, for example, if the gate extends linearly in the direction intersecting the arrangement direction of the plurality of the light-emitting elements and one of the drain region and the source region extends in the same direction, the size of the overlap area of the gate and the drain region or the source region serving as an electrode can be adjusted and thus the capacitance of the storage capacitor can be defined. According to this configuration, for example, the storage capacitor can be set to have the optimum capacitance such that the gate signal is written at high speed. In addition, electrical resistance of the gate or the like can be reduced. For example, the voltage to be applied to the gate of the driving transistor does not need to be decreased. Therefore, a sufficient driving current can flow in the light-emitting element, such that the light-emitting element can emit light with sufficient brightness.

In the printer head according to the aspect of the invention, it is preferable that the pixel circuit drives the light-emitting element through a voltage program method in which the driving current selectively flows in the light-emitting element according to a binary voltage corresponding to the data signal.

According to this configuration, when the pixel circuit receives the data signal, the driving current selectively flows in the light-emitting element through the voltage program method according to the binary voltage corresponding to the date signal. More specifically, for example, the operation of the driving transistor is controlled by the binary voltage indicating turning on or off the driving transistor, which is applied to the gate of the driving transistor, such that the driving current selectively flows in the light-emitting element. Therefore the photosensitive member can be exposed in a pattern corresponding to the data signal and thus the date signal can be written at high speed into the driving transistor, as compared to a current program method of the related art that is generally used in the organic EL display. For example, according to the voltage program method using the storage capacitor having the optimum capacitance, the time required to write the data signal into the pixel circuit can be set to be equal to or less than hundreds of nanosecondes.

In the printer head according to the aspect of the invention, it is preferable that the storage capacitor can be set such that the drop of the voltage on the gate is equal to or less than 0.3 V when the light-emitting element emits a required amount of light.

According to this configuration, under operation, the voltage applied to the gate may be decreased, for example, by electrical resistance of the gate. Therefore, it is preferable that the gate included in the storage capacitor is set such that the drop of the voltage on the gate when the printer head is under operation is equal to or less than 0.3 V. If the drop of the voltage on the gate is in the above-described range, the sufficient driving current can flow in the light-emitting element. More specifically, for example, by adjusting the length of the gate in the direction intersecting the arrangement direction of the light-emitting elements, the area of the gate can be set to be large and electrical resistance of the gate can be suppressed. Therefore, the drop of the voltage applied to the gate can be suppressed and the sufficient driving current can flow in the light-emitting element through the driving transistor.

In the printer head according to the aspect of the invention, the storage capacitor can be set such that a voltage drop caused by current leakage is equal to or less than 50 mV when the light-emitting element emits a required amount of light.

According to this configuration, the sufficient driving current can flow in the light-emitting element through the driving transistor. Here, the ‘current leakage’ according to the invention means, for example, a current flowing in the semiconductor layer having the channel region through the interlayer insulating film, which comes in contact with the gate, from the gate when the voltage according to the data signal is applied to the gate. Since such a current decrease the voltage to be applied to the gate of the driving transistor, such a current is preferably decreased as much as possible in order to increase luminance of the light-emitting element. Therefore, when the gate is set such that the voltage drop caused by the current leakage is equal to or less than 50 mV, even if the current leakage cannot be set to be zero, the luminance of the light-emitting element can be maintained in a range with no obstacle.

According to another aspect of the invention, an image forming apparatus includes the above-described printer head according to the aspect of the invention (including various configurations), the photosensitive member, a developing unit that develops an electrostatic latent image formed on the photosensitive member through the exposure by of the printer head to form a visible image, and a transferring unit that transfers the formed visible image onto a recording medium.

Since the image forming apparatus according to another aspect of the invention includes the above-described printer head according to the aspect of the invention, the image forming apparatus exposes the photosensitive member, such as a photosensitive drum or the like, at high speed and with high resolution. Therefore, the image forming apparatus can form a high-quality color or black and white image on a recording medium, such as a paper or the like, at high speed after developing and transferring. Further, the size of the image forming apparatus can be reduced by reducing the size of the printer head.

The effects and advantages of the invention will be apparent from embodiments described below.

### BRIEF DESCRIPTION OF THE DRAWINGS

The invention will be described with reference to the accompanying drawings, wherein like numbers reference like elements, and wherein:

FIG. 1 is a perspective view schematically showing a configuration of a printer head according to an embodiment of the invention;

FIG. 2A is a partially enlarged plan view schematically showing the printer head according to the embodiment of the invention;

FIG. 2B is a partially enlarged plan view schematically showing the printer head according to the embodiment of the invention;

FIG. 2C is a partially enlarged plan view schematically showing the printer head according to the embodiment of the invention;

FIG. 3 is a block diagram showing an electrical connection state of the printer head according to the embodiment of the invention;

FIG. 4 is an enlarged plan view of a pixel unit 201 included in the printer head according to the embodiment of the invention;

FIG. 5 is a cross-sectional view taken along the line V-V′ of FIG. 4;

FIG. 6 is a cross-sectional view showing a configuration of a driving transistor according to the embodiment of the invention;

FIG. 7 is a block diagram showing an electrical connection state of a printer head according to another embodiment of the invention; and

FIG. 8 is a cross-sectional view schematically showing main parts of a printer according to an embodiment of the invention.

### DETAILED DESCRIPTION OF EMBODIMENTS

Hereinafter, embodiments of the invention will be described in detail with reference to the drawings.

(Printer Head)

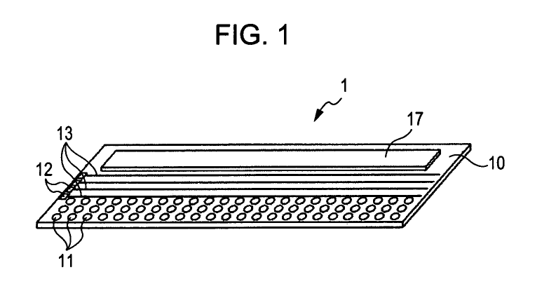

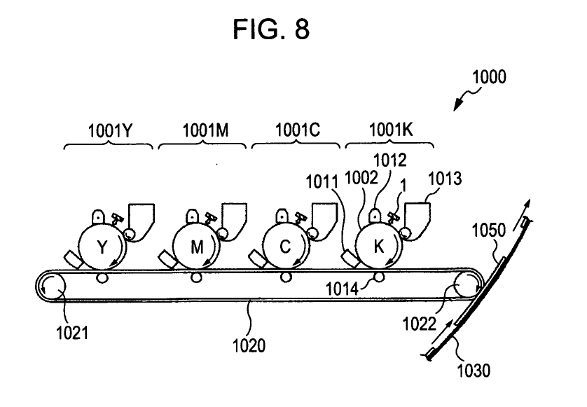

Hereinafter, a printer head according to the present embodiment will be described in detail with reference to FIGS. 1 to 7. Subsequently, a printer, which is an example of an image forming apparatus and to which a printer head according to the invention is applied, will be described with reference to FIG. 8. Moreover, in the embodiments, a printer head on which organic EL light-emitting elements, which are examples of current-driven light-emitting elements, are mounted and the organic EL light-emitting elements (hereinafter, referred to as light-emitting elements) are driven through a voltage program method is exemplified.

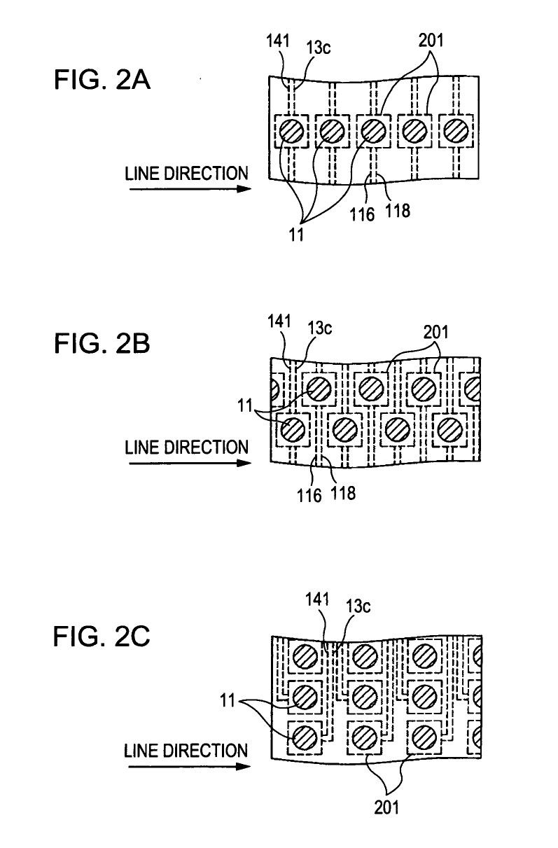

The schematic configuration of the printer head according to the present embodiment will be described with reference to FIGS. 1 and 2A to 2C. FIG. 1 is a perspective view schematically showing the configuration of the printer head according to the present embodiment. FIGS. 2A to 2C are partially enlarged plan views schematically showing the printer head, which show various specific examples of the planar layout of light-emitting units and pixel circuits.

In FIG. 1, the printer head 1 includes a substrate 10, a plurality of light-emitting units 11 that are linearly disposed on the substrate 10, external circuit connecting terminals 12 to which data signals are supplied, data line units 13 that are connected to the external circuit connecting terminals 12, and a line scanning circuit 17 that drives the light-emitting units 11.

The substrate 10 is made of a glass substrate, a quartz substrate, a semiconductor substrate, or the like, which extends in a longitudinal shape, and a horizontal direction in the drawing is referred to as ‘longitudinal direction’. Moreover, the ‘longitudinal shape’ according to the invention means a state in which a gate electrode or the like, which is described below, is provided along a traverse direction of the substrate 10. The external circuit connecting terminals 12 are disposed along an edge of the substrate 10. Some of the plurality of external circuit connecting terminals 12 are supplied with binary data signals, which indicate turning-on or turning-off of the pixels, from a printer engine or the like serving as a data signal source. Further, other terminals of the plurality of external circuit connecting terminals 12 are supplied with various signals, such as power signals, clock signals, control signals, or the like, which are required for the operation of the line scanning circuit 17, pixel circuits described below, or the like, or for supplying power.

One or more of the data line units 13 is disposed along the longitudinal direction of the substrate 10. The data line units 13 are supplied with data signals from the data signal source via the external circuit connecting terminals 12. The line scanning circuit 17 is attached to the substrate 10 through a subsequent process or is integrated therein. As described below, the line scanning circuit 17 is configured to sequentially supply line scanning signals to the respective pixel circuits so as to control the light-emission timings of the respective light-emitting units 11.

Like various specific examples of the planar layout of the light-emitting units 11 shown in FIGS. 2A to 2C, the plurality of light-emitting units 11 are disposed in a line direction corresponding to the longitudinal direction of the substrate 10. The light-emitting units 11 may be provided in a single line (FIG. 2A), in a plurality of lines in a zigzag pattern (FIG. 2B), or in a plurality of lines in a matrix shape (FIG. 2C). In any specific example, a single light-emitting element 11 is provided for each pixel unit 201. The respective pixel units 201 are supplied with the line scanning signals from the line scanning circuit 17 shown in FIG. 1 through line scanning signal lines 141. At this time, the data signals are supplied to the pixel units 201 via lead lines 13c of the data line units 13. In addition, the respective pixel units 201 are supplied with high-potential power and low-potential power via high-potential power lines 116 and low-potential power lines 118.

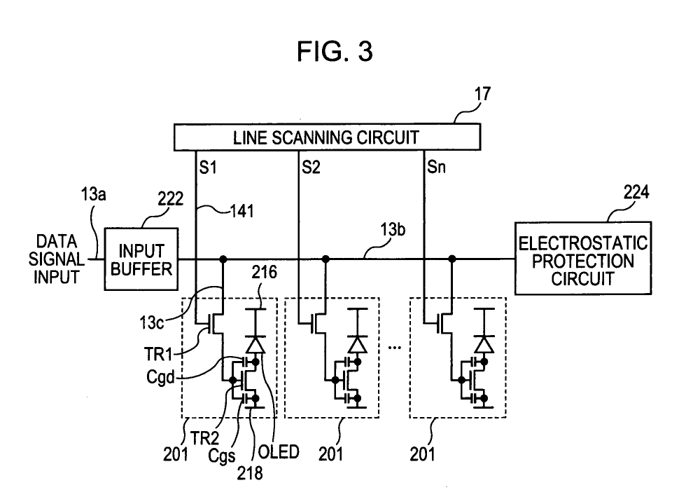

Next, a specific example of the pixel units 201 and various wiring lines connected to the pixel units 201 will be described with reference to FIG. 3. FIG. 3 is a block diagram schematically showing the specific example of the electrical configuration of the printer head 1. Specifically, FIG. 3 is a block diagram when the light-emitting elements OLED are driven according to a voltage program method. Moreover, in FIG. 3, the same parts as those in FIGS. 1 and 2A to 2C are represented by the same reference numerals and the descriptions thereof will be omitted.

In FIG. 3, each data line unit 13 includes a data signal supply line 13a, an input buffer 222, a main line 13b, and the lead lines 13c. In addition, the input buffer 222 that holds a binary voltage and an electrostatic protection circuit 224 are provided at an end of the main line 13b. Although the pixel units 201 are horizontally disposed in a line in FIG. 3, the pixel units 201 may be disposed based on various layouts shown in FIGS. 2A to 2C. In the specific example of FIG. 3, in particular, the input buffer 222 generates the binary voltage according to the binary data signal supplied from the data signal supply line 13a and supplies the binary voltage to the pixel units 201 via the lead lines 13c. The input buffer 222 and the electrostatic protection circuit 224 can stably hold the binary voltage on the main line 13b and the lead lines 13c of the data line unit 13 at a voltage corresponding to turn-on or turn-off the binary data signal with an additional power supply. Accordingly, the pixel units 201 can be driven according to the voltage program method via the data line units 13. That is, the write operation of the data signal into the pixel unit 201 can be performed by the binary voltage of the data signal appearing on the main line 13b and the lead lines 13c via the data line unit 13. The line scanning circuit 17 includes a shift register circuit and is configured to sequentially supply the line scanning signals S1, S2, . . . , Sn to the line scanning signal lines 141.

The pixel unit 201 includes a control transistor TR1, a driving transistor TR2, storage capacitors Cgd and Cgs, a light-emitting element OLED, a cathode 216, and an anode 218.

The light-emitting element OLED functions as the light-emitting unit 11 shown in FIG. 1, 2A, 2B, or 2C. The detailed configuration of the light-emitting element OLED is identical or similar to that of the light-emitting element in an existing organic EL display panel. The line scanning signal Si (where i=1, 2, n) is supplied to the gate of the control transistor TR1. A source of the control transistor TR1 is supplied with the binary voltage of the data signal from the lead line 13c. When the corresponding line scanning signal Si is supplied to the gate of the control transistor TR1, the binary voltage is supplied to a gate of the driving transistor TR2 via the source and drain of the control transistor TR1.

The driving transistor TR2, the storage capacitors Cgd and Cgs constitute an example of the ‘pixel circuit’ according to the invention.

The driving transistor TR2 is turned on when one (for example, high-level voltage) of the binary voltage values of the data signal is applied to the gate thereof. At this time, the driving current of the light-emitting element OLED flows between the cathode and anode 216 and 218, to which predetermined potentials are supplied. Therefore, the light-emitting element OLED emits light, that is, the light-emitting element is turned on. On the contrary, the driving transistor TR2 is turned off when the other voltage of the binary voltage (for example, the low-level voltage) of the data signal is applied to the gate thereof. At this time, the driving current of the light-emitting element OLED does not flow between the cathode and anode 216 and 218, to which the predetermined potentials are supplied.

The storage capacitors Cgs and Cgd are electrostatic capacitances formed between the gate and the source of the driving transistor TR2 and between the gate and the drain thereof, respectively. Each of the storage capacitors Cgs and Cgd store a predetermined electric charge when one (for example, high-level voltage) of the binary voltage values of the data signal is applied to the gate of the driving transistor TR2. The electric charge held in each of the storage capacitors Cgd and Cgs is maintained as it is after the supply time of the gate signal has lapsed and a voltage corresponding to the electric charge continues to be applied to the gate of the driving transistor TR2. Therefore, even when the supply time of the gate signal has lapsed, the driving transistor TR2 maintains the on state until the subsequent gate signal is written, and the light-emitting element OLED continuously emits light. Moreover, if electric charge corresponding to the voltage of the data signal is held in at least one of the storage capacitors Cgd and Cgs, the light-emitting element can continuously emit light.

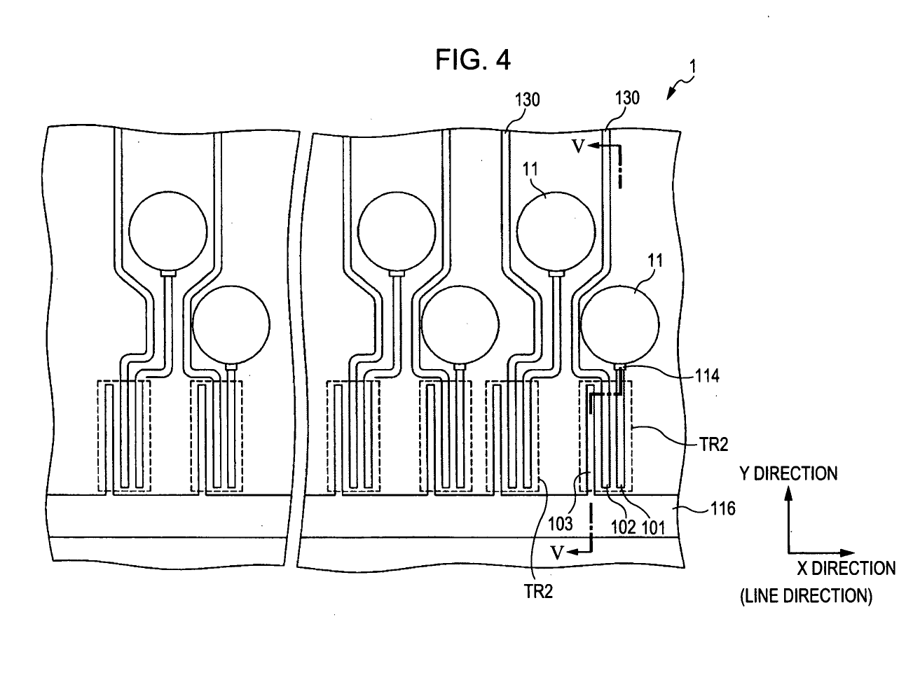

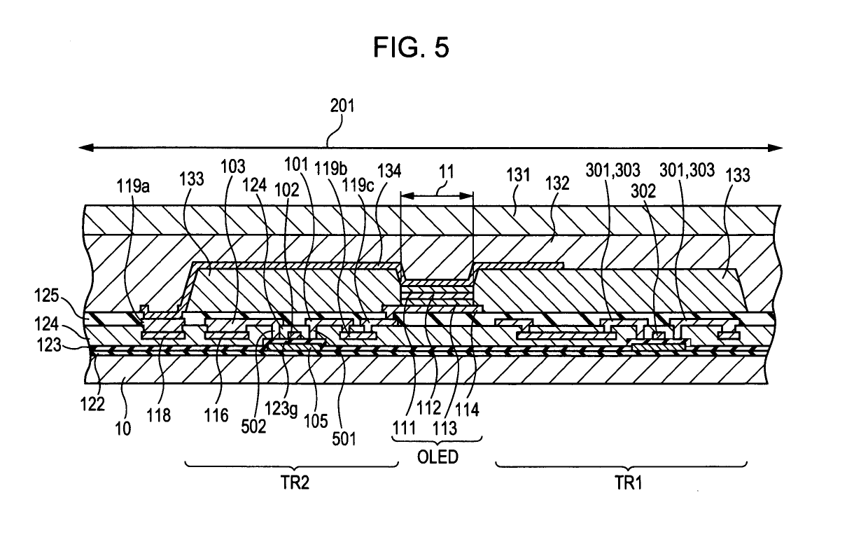

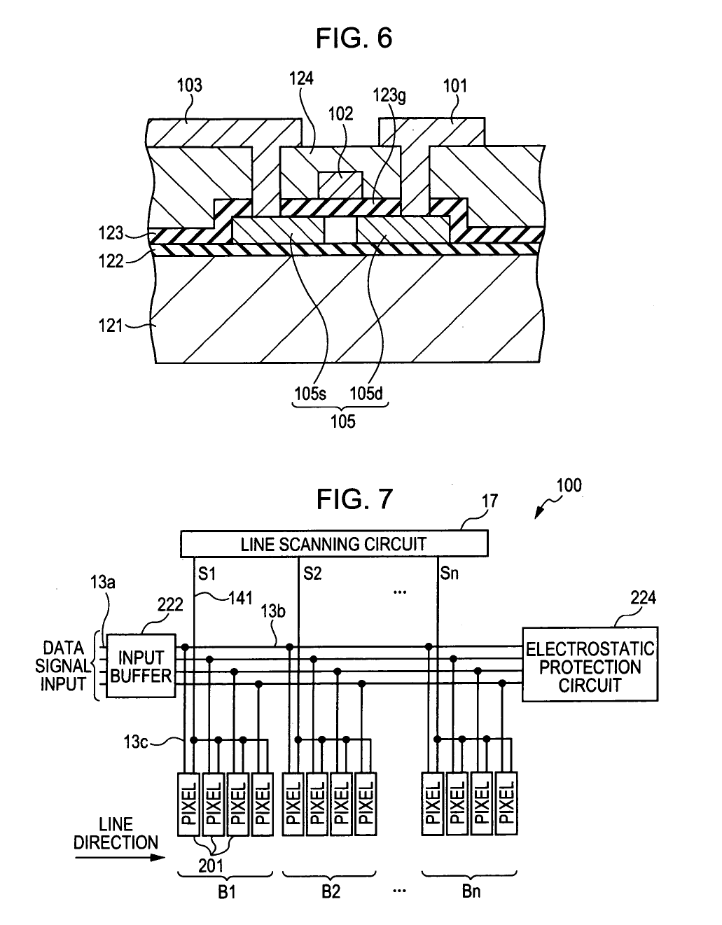

Next, the specific configuration of the pixel unit 201 included in the printer head 1 will be described with reference to FIGS. 4 to 6. FIG. 4 is a plan view of the pixel units 201 disposed linearly in a magnified scale. FIG. 5 is a cross-sectional view taken along the line V-V′ of FIG. 4. FIG. 6 is an enlarged cross-sectional view of the driving transistor TR2. Although the detailed configuration of the pixel unit 201 is described by way of the pixel units 201 disposed in the zigzag pattern shown in FIG. 2B in FIGS. 4 to 6, it is needless to say that the pixel units 201 may be disposed as shown in FIGS. 2A and 2C.

In FIGS. 4 and 5, the pixel unit 201 includes the light-emitting unit 11 having the light-emitting element OLED, the control transistor TR1, and the driving transistor TR2.

In FIG. 4, the driving transistor TR2 includes a drain electrode 101, a gate electrode 102, and a source electrode 103, all of which extend in a Y direction orthogonal to an X direction (line direction) in the drawing. The drain electrode 101 is electrically connected to a hole-injecting electrode 114 of the light-emitting element OLED, and the source electrode 103 is electrically connected to a high-potential wiring line 116 extending in the X direction in the drawing. Herein, the high-potential wiring line 116 is a power line to supply the driving current to the light-emitting elements OLED. The gate electrode 102 is electrically connected to a wiring line 130 that extends in the Y direction of the drawing so as to detour around the light-emitting unit 11. The wiring line 130 is electrically connected to the drain of the control transistor TR1 (not shown in FIG. 4) and thus, when the control transistor TR1 is turned on, the voltage according to the data signal is applied to the gate electrode 102. Moreover, although the gate electrode 102 is a rectangular single gate in the embodiment, the gate electrode 102 may be double gates extending in the Y direction. In addition, the control and driving transistors TR1 and TR2 may have LDD (Lightly Doped Drain) structures.

The pixel units 201 are disposed at narrow intervals in the X direction, and thus it is difficult to provide various elements, wiring line structures for forming an element structure, and the like in the pixel unit 201 or between the pixel units 201 in the X-direction. For example, in order to increase the image quality of a printed image to 600 dpi, the interval between the pixel units 201 needs to be narrowed accordingly. Thus, it is difficult to secure a space for forming the storage capacitor in the pixel unit 201 or between the pixel units 201.

Therefore, in the printer head 1, the drain electrode 101, the gate electrode 102, the source electrode 103, and a drain region 105d and a source region 105s, which are described below, extend in the Y direction, such that at least one of the storage capacitors Cgd and Cgs can be formed. Moreover, the detailed configuration of each of the storage capacitors Cgd and Cgs will be described with reference to FIG. 6. In addition, for convenience of explanation, a bank 133, the cathode 134, a light-emitting-material holding layer 132, a sealing portion 131, and the control transistor TR1, which are shown in FIG. 5, are not shown in FIG. 4.

In FIG. 5, insulating films 122 and 123, a gate protective film 124, and an insulating film 125 are sequentially formed on the substrate 10, and the light-emitting element OLED included in the light-emitting unit 11 is formed on the insulating film 125. The light-emitting element OLED includes an electron-injecting layer 111, a light-emitting layer 112, a hole-injecting/transporting layer 113, and a hole-injecting electrode 114 sequentially from the above in the drawing, in a space surrounded by the bank 133 provided on the insulating film 125. Moreover, it is needless to say that the configuration of the light-emitting element OLED is not limited to the configuration of the embodiment, but any configuration may be used as long as it can be applied as the organic EL light-emitting element. The electron-injecting electrode 111 is electrically connected to the cathode 134, and the cathode 134 extends up to the upper side of the bank 133 and is electrically connected to the low-potential wiring line 118 via a conductive portion 119a. The light-emitting-material holding layer 132 and the sealing portion 131 are formed on the cathode 134 in the drawing. The hole-injecting electrode 114 is electrically connected to the drain electrode 101 of the driving transistor TR2 via conductive portions 119b and 119c.

Contact holes 501 and 502 are formed in the gate protective film 124, which is an insulating film covering the gate electrode 102. The contact holes 501 and 502 pass through the gate protective film 124 and the gate insulating film 123g, which are examples of ‘interlayer insulating films’ according to the invention, from the surface of the gate-protective film 124 and reach the semiconductor layer 105 of the driving transistor TR2. Conductive films constituting the drain electrode 101 and the source electrode 103 are continuously formed along the inner walls of the contact holes 501 and 502 to reach the surface of the semiconductor layer 105. The drain electrode 101 is electrically connected to the hole-injecting electrode 114, and the source electrode 103 is electrically connected to the high-potential wiring line 116. The gate electrode 102 is formed to face the semiconductor layer 105 with the gate insulating film 123g therebetween and is covered with the gate protective films 124 to be electrically isolated from the drain electrode 101 and the source electrode 103.

The control transistor TR1 is provided horizontally in the drawing on the substrate 10 via the insulating film 122 so as to detour around the light-emitting unit 11, and the drain electrode 301 (303) of the control transistor TR1 is electrically connected to the gate electrode 102 of the driving transistor via a wiring line (not shown). The source electrode 301 (303) of the control transistor TR1 is electrically connected to the lead line 13c of the data line unit 13. The gate electrode 302 of the control transistor TR1 is electrically connected to the line scanning signal line 141 of the line scanning circuit 17.

When the printer head 1 having such a configuration is driven, if the line scanning signal Si is supplied to the gate electrode 302 of the control transistor TR1, the gate signal is supplied to the gate electrode 102 of the driving transistor TR2 from the drain electrode 301 (303) of the control transistor TR1. For example, when the high-level voltage from the voltages according to the gate signal is applied to the gate electrode 102 of the driving transistor TR2, a driving current flows from the high-potential wiring line 116 to the light-emitting element OLED via the semiconductor layer 105 including the channel region of the driving transistor TR2. Then, the light-emitting element OLED emits light toward the lower side of the drawing. The electric charge corresponding to the voltage of the gate signal is held in at least one of the storage capacitors Cgd and Cgs described below, and thus the driving transistor TR2 is maintained in the on state for a predetermined time. Accordingly, even when the supply time of the data signal has lapsed, the light-emitting element can continuously emit light.

Next, the storage capacitors Cgd and Cgs will be described with reference to FIG. 6.

In FIG. 6, the semiconductor layer 105 included in the driving transistor TR2 includes the drain region 105d that is electrically connected to the drain electrode 101 and the source region 105s that is electrically connected to the source electrode 103. The drain region 105d and the source region 105s are formed on the semiconductor layer 105, for example, by doping ions as impurities. More specifically, if the driving transistor TR2 is an n-channel thin film transistor, the drain region 105d and the source region 105s are formed on the semiconductor layer 105 by doping n-type impurities. It is needless to say that the driving transistor TR2 may be a p-channel thin film transistor and, in this case, the drain region 105d and the source region 105s are formed on the semiconductor layer 105 by doping p-type impurities.

The gate electrode 102 is an example of ‘one of a pair of capacitance electrodes’ according to the invention and constitutes the storage capacitors Cgd and Cgs, together with the drain region 105d and the source region 105s, which are examples of ‘the other capacitance electrode’ according to the invention, and the gate-insulating film 123g. Here, the horizontal direction of the drawing is an example of ‘the arrangement direction’ according to the invention, and the depthwise direction of the drawing is an example of ‘the direction intersecting the arrangement direction’ according to the invention. The length of the gate electrode 102, the drain region 105d, or the source region 105s disposed along the depthwise direction in the drawing can be set without being influenced by the pitch of the pixel unit 201 along the horizontal direction in the drawing. Therefore, the capacitance value of the storage capacitor Cgd or Cgs can be defined by the length of the gate electrode 102, the drain region 105d, or the source region 105s along the depthwise direction in the drawing.

More specifically, the sizes of the gate electrode 102, the drain region 105d, and the source region 105s in the depthwise direction of FIG. 6 extend, as occasion demands, without increasing the sizes of the gate electrode 102, the drain region 105d, and the source region 105s in the horizontal direction. Therefore, the storage capacitors Cgd and Cgs can be formed by using the element structure of the driving transistor TR2, and the capacitance of the storage capacitor Cgd or Cgs can be defined in a state in which the sizes of the gate electrode 102, the gate insulating film 123g, the drain region 105d, and the source region 105s in the horizontal direction of FIG. 6 are constant.

Meanwhile, the driving transistor TR2 can be patterned such that the edge portions of the gate electrode 102 face the drain region 105d and the source region 105s when manufactured. More specifically, the gate electrode 102 can be formed in such a manner that the edges of the gate electrode 102 overlap at least one of the drain region 105d and the source region 105s. In addition, the driving transistor TR2 may be a so-called “self-alignment type” thin film transistor in which impurities are doped in the drain region 105d and the source region 105s with the gate electrode 102 serving as a mask.

Here, preferably, the storage capacitors Cgd and Cgs are set such that a voltage drop of the data signal at the gate electrode 102 is equal to or less than 0.3 V when the light-emitting element OLED emits a required amount of light. The electrical resistance of the gate electrode 102 or the like can be reduced by setting the sizes of the extended portion of the gate electrode 102 or the like along the depthwise direction in the drawing, such that the voltage drop of the data signal is equal to or less than 0.3 V. Therefore, a voltage according to the data signal can be applied precisely to the gate of the driving transistor TR2, and a driving current can flow in the light-emitting element OLED, such that the light-emitting element OLED can emit light according to a required image quality. Then, the quality of electrostatic latent image formed on a photosensitive member can be increased and thus the quality of the printed image can be increased, which is a significant advantage. Here, as an index of the amount of emission to allow the printed image to have sufficient image quality, for example, a luminance of about 5500 cd/m² is given as an example. Accordingly, the electrical resistance of the gate electrode 102 or the like may be reduced so that the light-emitting element OLED can emit light with such a luminance.

In addition, preferably, the storage capacitors Cgd and Cgs are set such that the voltage drop caused by current leakage is equal to or less than 50 mV when the light-emitting element OLED emits a required amount of light. Here, the ‘required amount of emission’ means the amount of light that is required for an image finally formed by an image forming apparatus, such as a printer or the like, and it may be set according to the quality of an image to be formed respectively. When the voltage according to the data signal is applied to the gate electrode 102, for example, a current may flow to the drain or source of the driving transistor TR2 from the gate electrode 102 via the gate insulating film 123g or the gate protective film 124. This current decreases the voltage of the gate signal, which is supplied to the gate electrode 102 of the driving transistor TR2. Thus, in order to increase the luminance of light emitted by the light-emitting elements OLED, it is preferable to decrease this current as much as possible. Therefore, even when the current leakage cannot be made zero, if the size of the gate electrode 102 or the like along the depthwise direction in the drawing is set such that the voltage drop caused by the current leakage is equal to or less than 50 mV, the current leakage can be sufficiently reduced. Then, the luminance of light emitted by the light emitting element OLED can be maintained in a range with no obstacle so as to form a high-quality image.

As described above, in the embodiment, since the pixel unit 201 is driven according to the voltage program method, the write time of the data signal can be shortened by setting the storage capacitors Cgd and Cgs to have the required capacitance values. Therefore, the pixel unit 201 can be driven at high speed, as compared to the case in which the pixel unit is driven according to the current program method of the related art.

In addition, when the thickness of the gate insulating film 123g is maintained constant, the storage capacitors Cgd and Cgs can be set, without shortening the distance between the gate electrode 102, and the drain region 105d and the source region 105s. In this case, the length of the gate electrode 102, the drain region 105d, or the source region 105s in the horizontal direction of FIG. 6 is maintained constant. Therefore, when the printer head 1 is operated, the electric field concentration can be reduced in the gate electrode 102 and the voltage breakdown of the gate insulating film 123g can be reduced.

Further, the drain electrode 101 and the source electrode 103 may be used as an example of ‘the other capacitance electrode’ according to the invention, and the gate protective film 124 may be used as an example of ‘the interlayer insulating film’ according to the invention. In this case, the storage capacitors Cgd and Cgs may include the gate electrode 102, the gate protective film 124, the drain electrode 101, and the source electrode 103.

The size of the gate protective film 124, the drain electrode 101, or the source electrode 103 described above and disposed along the depthwise direction in the drawing can be set to a required size in the same manner as the size of the gate insulating film 123g, the drain region 105d, or the source region 105s. In addition, when the printer head 1 is operated, the electric field concentration in the gate electrode 102, the drain electrode 101, and the source electrode 103 can be reduced, such that the voltage breakdown of the gate protective film 124 is decreased. Therefore, it is possible to form the storage capacitors Cgd and Cgs having the required capacitance values and to increase the reliability of the printer head 1, even when the pixel units 201 are disposed at narrow intervals. In addition, if the pixel unit 201 is driven according to the voltage program method, like the embodiment, the capacitance values of the storage capacitors Cgd and Cgs can be set to the required values, and the data signal can be written to the pixel unit 201 at high speed.

FIG. 7 is a block diagram showing a printer head according to another embodiment of the invention. Moreover, the same parts as those in FIGS. 1 to 7 are represented by the same reference numerals.

In FIG. 7, a printer head 100 includes a plurality of data signal input lines 13a and pixel blocks B1, B2, . . . , Bn, each having a plurality of pixel units 201. Although the printer head 100 has the same size as that of the printer head 1, the printer head 100 includes more pixel units 201, which are disposed at narrower intervals than those in the printer head 1. The storage capacitor can also be formed in the printer head 100 by using the element structure of the driving transistor included in the pixel unit in the same manner as the printer head 1. That is, the narrower the intervals between the light-emitting elements OLED or the pixel units 201 is, the higher the effectiveness of the storage capacitor using the element structure of the driving transistor is.

(Printer)

Next, a printer having the printer head 1 described above according to an embodiment of the invention will be described in detail with reference to FIG. 8. FIG. 8 is a cross-sectional view showing main parts of the printer according to the present embodiment. Moreover, in the embodiment described below, a color printer having four printer heads 1 for YMCK is exemplified.

In FIG. 8, a printer 1000 includes four image forming units 1001Y, 1001M, 1001C, and 1001K for YMCK. Each unit includes a photosensitive drum 1002, which is an example of a ‘photosensitive member’ according to the invention, a cleaner 1011, a charger 1012, the printer head 1, and a developer 1013, which is an example of a ‘developing unit’ according to the invention. The cleaner 1011, the charger 1012, the printer head 1, and the developer 1013 are disposed around the photosensitive drum 1002 sequentially.

Next, the configuration and the operation of the printer 1000 according to the embodiment will be described.

In FIG. 8, the cleaner loll removes a toner used for a previous cycle and remained on the surface of the photosensitive drum 1002, and then the surface of the photosensitive drum 1002 is charged by a corona discharge or the like of the charger 1012 for the next cycle. Next, the electrostatic latent image according to the data signal is formed on the surface of the photosensitive drum 1002 through the exposure according to the data signal from the printer head 1 of the above-described embodiment. Then, the developer 1021 develops an image by using a toner of a color corresponding to each unit from yellow (Y), magenta (M), cyan (C), and black (K) so as to form a toner image on the surface of the photosensitive drum 1002 as a visible image by the toner adhesion. On the other hand, a transfer belt 1020 is rotated by rollers 1021 and 1022 or the like. The toner image on the photosensitive drum 1002 is transferred on the transfer belt 1020 at a location where the transfer belt 1020 face the photosensitive drum 1002 in such a manner that the transfer belt 1020 is pressed by transfer rollers 1014 from the back. The transferred image is transferred on a copy paper or the like fed by a feeding device 1030. Then the image-formed paper is discharged to a discharge tray through a fixing device or the like (not shown).

As described above, the printer 1000 according to the present embodiment includes the above-described printer head 1, such that the photosensitive drum 1002 can be exposed at high speed and with high resolution. Also, for example, the storage capacitor can be provided in the printer head 1 so as to perform the voltage program method, even when the size of the printer head 1 is reduced. Therefore, the printer can be reduced in size and have an increased image quality. Particularly, in FIG. 8, the printer head 1 can be easily formed to have a required length in the longitudinal direction along a direction of the rotational shaft of the photosensitive drum 1002, and the length of the printer head 1 along a circumferential direction of the photosensitive drum 1002 can be drastically shortened to be not more than the length in the widthwise. Therefore, it is advantageous to apply the printer head 1 described in the present embodiment to the printer having a configuration in which various devices are disposed to surround the periphery of the photosensitive drum 1002, as shown in FIG. 8.

It should be understood that the invention is not limited to the above-described embodiments, and various changes and modifications can be made within the scope without departing from the subject matter or spirit of the invention as defined by the appended claims and the entire specification. Also, a printer head and a printer that accompany such modifications still fall within the technical scope of the invention.

What is claimed is:

1. A printer head comprising:
a plurality of current-driven light-emitting elements that are linearly disposed so as to expose a photosensitive member; and
a plurality of pixel circuits, each having a driving transistor that is provided for each light-emitting element so as to cause a driving current to flow in the light-emitting element according to a data signal, and a storage capacitor that holds an electric charge according to the data signal and having a gate of the driving transistor as one of a pair of capacitance electrodes and an interlayer insulating film interposed between the pair of capacitance electrodes as a dielectric film, such that a voltage according to the electric charge held in the storage capacitor is applied to the gate of the driving transistor.

2. The printer head according to claim 1,
wherein the storage capacitor is constituted by only the pair of capacitance electrodes and the dielectric film.

3. The printer head according to claim 1,
wherein the other capacitance electrode includes at least one of a source region and a drain region in a semiconductor layer that includes a channel region of the driving transistor.

4. The printer head according to claim 1,
wherein the other capacitance electrode includes at least one of a source electrode and a drain electrode of the driving transistor.

5. The printer head according to claim 1,
wherein the plurality of pixel circuits are disposed in the arrangement direction of the plurality of light-emitting elements, and at least a portion of the gate serving as the one of the capacitance electrodes and the other capacitance electrode longitudinally extends along a direction intersecting the arrangement direction.

6. The printer head according to claim 1,
wherein the pixel circuit drives the light-emitting element through a voltage program method in which the driving current selectively flows in the light-emitting elements according to a binary voltage corresponding to the data signal.

7. The printer head according to claim 1,
wherein the storage capacitor is set such that the drop of the voltage on the gate is equal to or less than 0.3 V when the light-emitting element emits a required amount of light.

8. The printer head according to claim 1,
wherein the storage capacitor is set such that the voltage drop caused by current leakage is equal to or less than 50 mV when the light-emitting element emits a required amount of light.

9. An image forming apparatus comprising:
the printer head according to claim 1;
the photosensitive member;
a developing unit that develops an electrostatic latent image formed on the photosensitive member through the exposure by of the printer head to form a visible image; and
a transferring unit that transfers the formed visible image onto a recording medium.
